(19) United States
(12) Patent Application Publication
(10) Pub. No.: US 2014/0058544 A1
(43) Pub. Date: Feb. 27, 2014

(54) APPARATUS AND METHOD FOR THE DEPLOYMENT AND MONITORING OF CONTROL LOGIC

(71) Applicant: GE INTELLIGENT PLATFORMS, INC., Charlottesville, VA (US)

(72) Inventor: Kenneth DICKIE, Edmonton (CA)

(73) Assignee: GE INTELLIGENT PLATFORMS, INC., Charlottesville, VA (US)

(21) Appl. No.: 13/760,672

(22) Filed: Feb. 6, 2013

Related U.S. Application Data
(60) Provisional application No. 61/691,293, filed on Aug. 21, 2012.

(51) Int. Cl. G05B 11/01

(52) U.S. Cl. CPC G05B 11/01
USPC 700/83

(57) ABSTRACT

An automation controller is selected using a graphical user interface. The graphical user interface presents an interactive map of a geographical area to a single user and the interactive map has one or more selectable and navigable display levels. Control logic is stored exclusively at the communication network and at least some a portion of the control logic is stored in a data storage device at the communication network. The portion is available to a plurality of secure users. After selecting the automation controller, the graphical user interface is used to select at least one function involving the automation controller. The at least one function or action is one or more of configuring operating characteristics of the automation controller and initially deploying the control logic to the automation controller. In other aspects, the at least one function may include re-deploying updated versions of the control logic to the automation controller or monitoring an operation of the control logic that has been deployed at the automation controller.

### CROSS REFERENCES TO RELATED APPLICATIONS

This application claims benefit under 35 U.S.C. §119 (e) to U.S. Provisional Application No. 61/691,293 entitled “Solution Configurator in a Cloud-based System” filed Aug. 21, 2012, the content of which is incorporated herein by reference in its entirety.

Utility application entitled “Creating and Integrating Control Logic” naming as inventor Kenneth Dickie and having attorney docket number 262587 (102672); and

Utility application entitled “Apparatus and Method for Providing Secure Communications in a Network” naming as inventor Gregory Dunn and having attorney docket number 262803 (102674), both of which are being filed on the same day as the present application and the contents of both of which are incorporated herein by reference in their entireties.

### BACKGROUND OF THE INVENTION

1. Field of the Invention

The subject matter disclosed herein relates to the deployment and monitoring of control logic.

2. Brief Description of the Related Art

Automated devices perform various functions and these devices typically include a controller or control device that controls or manages the execution of these functions. For example, robotic controllers (e.g., those that utilize microprocessors) often control the functions of a robot and the robot can perform various manufacturing tasks. Assembly line controllers are used to control the various functions performed on or at an assembly line. A consumer device controller may be used to control the operation and functioning of any type of consumer device (e.g., security system, lighting system, heating system, traffic light, or pump controller). Together, these types of controllers provide automated functions and are generally referred to as automation controllers.

An automation controller typically includes and utilizes control logic to perform its functions. Control logic solutions may include computer software and/or computer hardware that performs various predetermined functions. For example, an assembly line controller (e.g., for a bottling plant) may include a microprocessor that operates programmed computer software to regulate the speed and other functions associated with operating an assembly line that fills and caps the bottles. In another example, a controller may also include a microprocessor running programmed computer software that regulates various device parameters (e.g., temperature, pressure, or operating speed). In yet another example, a water system controller may include control logic that controls pumps and sprinklers.

In conventional approaches for obtaining control logic, clients contact a provider and describe their requirements. After purchase, the client is then shipped all the components (e.g., hardware, logic, HMI, and so forth) separately, and these components are assembled and installed by installers on site. At this point, the provider's interaction with the client ends. These conventional approaches have relied exclusively upon manually installing and testing the components. This has created inefficiencies and user frustration with these conventional approaches.

### BRIEF DESCRIPTION OF THE INVENTION

Approaches for deploying and monitoring the operation of control logic are provided. More specifically, embodiments of the present invention provide an interactive web site where users can deploy and monitor control logic. In some aspects, the convenience of the present approaches generates more visits to the website resulting in more income. The approaches described herein also allow users to view information involving multiple automation controllers in one place.

In one approach for operating automation controllers (that are coupled to a communication network), an automation controller is selected using a graphical user interface. The graphical user interface presents an interactive map of a geographical area to a single user and the interactive map has one or more selectable and navigable display levels. Control logic is stored exclusively at the communication network and at least some portion of the control logic is stored in a data storage device at the communication network. The portion of control logic is available to a plurality of authenticated users with appropriate permissions. After selecting the automation controller, the graphical user interface is used to select at least one function involving the automation controller. The at least one function or action is one or more of configuring operating characteristics of the automation controller and initially deploying the control logic to the automation controller. In other aspects, the function may also include re-deploying updated versions of the control logic to the automation controller or monitoring an operation of the control logic that has been deployed at the automation controller.

In still other aspects, building the control logic comprises manually creating the control logic at the communication network. In yet other examples the control logic is purchased from a third party vendor.

In some other aspects, a group of users is formed. In some examples, all members of the group may be notified when an update to the control logic occurs.

In yet other aspects, a group of users is formed and the graphical user interface provides a single point of control for interactions with the automation controller for at least a portion of the group. In still other examples, a group of users is formed and the graphical user interface allows collaboration between at least a portion of the users of the group.

In still others of these embodiments, an apparatus for operating automation controllers that are coupled to a communication network includes a graphical user interface and a controller. The graphical user interface has an input and an output.

The controller is coupled to the interface and is configured to receive a selection of an automation controller from the input of the graphical user interface. The graphical user interface presents an interactive map of a geographical area to a single user. The interactive map has one or more selectable and navigable display levels and the controller is configured to, after selecting the automation controller, cause the service user interface to select at least one function involving the automation controller. The at least one function or action is configuring operating characteristics of the automation controller and/or initially deploying control logic to the automation controller. Other examples of functions or actions are possible.

### BRIEF DESCRIPTION OF THE DRAWINGS

For a more complete understanding of the disclosure, reference should be made to the following detailed description and accompanying drawings wherein:

FIG. 1 comprises a block diagram of a system that deploys and monitors control logic according to various embodiments of the present invention;

FIG. 2 comprises a flow chart that shows an approach for deploying and monitoring control logic according to various embodiments of the present invention;

FIG. 3 comprises a block diagram of an apparatus that is configured to deploy and monitor control logic according to various embodiments of the present invention;

FIG. 4 shows an example of a screen showing the general location of a plurality of automation controllers according to various embodiments of the present invention;

FIG. 5 shows a successively narrower geographic view on a screen according to various embodiments of the present invention;

FIG. 6 shows a successively narrower geographic view on a screen according to various embodiments of the present invention;

FIG. 7 shows a particular automation controller has been chosen and the camera view of that automation controller is displayed on a screen according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION OF THE INVENTION

In the approaches described herein, the deployment and monitoring of control logic is facilitated. For instance, an interactive web site where users can deploy and monitor control logic is provided. The approaches described herein are easy to use and deploy, increase revenues for control logic providers, provide a central platform for monitoring and deploying control logic, and generally increase user satisfaction.

The online system described herein allows a user to manage the life-cycle of automation controllers. For example, when a user logs onto an appropriate web site a visual image of an area of interest (e.g., a “hot spot” like a plant) is displayed with indicators for various control logic solutions (e.g., PLC logic, HMI logic, data analysis tools, control hardware, and monitoring tools) and other “hotspots” (i.e., points of special interest) which, in some examples, have been previously determined. They can be at an upper level and refer to an entire plant or refer to a single device as well. By clicking on hotspots, users are able to zoom into another level displaying another map/photo image. Users are able to manage the control logic they are monitoring and create new control logic (e.g., created by themselves or purchased from third parties). The tools so-created can be shared across multiple permissible users to allow system collaboration.

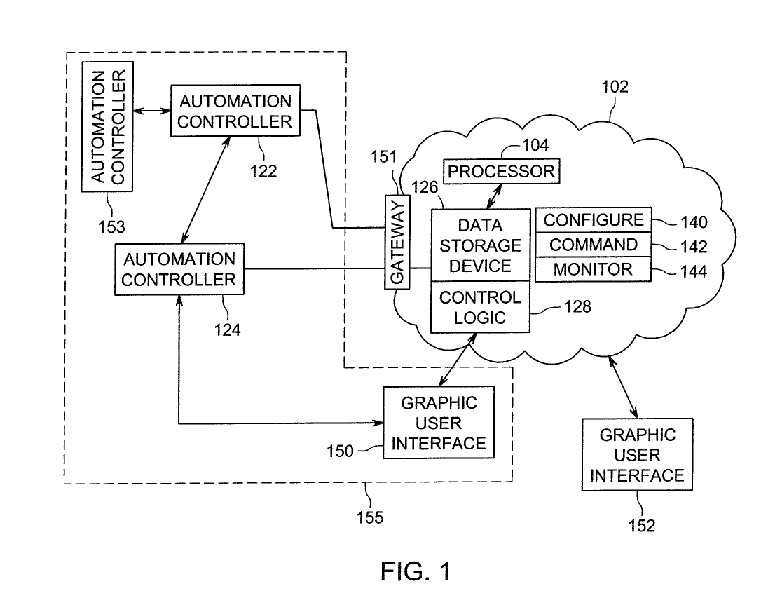

Referring now to FIG. 1, one example of a system for deploying and monitoring control logic is described. The system includes a communication network 102. The communication network 102 is coupled to a private network 155. The private network 155 includes a first automation controller 122, a second automation controller 124, and a third automation controller 153. The private network 155 may be disposed at any factory, office, home, power plant, device, communication facility (e.g., a base station) or any other location that may advantageously use an automation controller or any combination of locations. The network 155 also includes a graphical user interface 150 that is coupled to the automation controller 124. The GUI 150 may also couple to the other automation controllers.

The communication network 102 is any type of communication network such as the Internet, a computer network, a cellular telephone network, or any combination of these or other networks. In this respect, the communication network 102 may include any number of devices such as computers, access points, routers, and servers, to mention a few examples.

The communication network 102 includes a processor 104 and a memory 126. The memory 126 (which can be any type of memory device or combination of memory devices) includes a control logic representation 128.

The control logic representation 128 is a description (in one example, implemented as programmed software or code) that represents the control logic at one or more of the automation controllers 122,124, or 153. More specifically, the control logic representation 128 describes the functions, workings, operation, inputs, outputs, and other characteristics of the operation of the associated control logic of the automation controller 122, 124, or 153. In other aspects, the control logic representation 128 may be hardware, software, or combinations of hardware and software elements. In one aspect, the control logic representation 128 is the same as the control logic at one or all of the automation controller 122, 124, and 153. Consequently, changes can be made to the control logic representation 128 (without halting the operation of the automation controller 122, 124, or 153) and these can be later downloaded to the automation controller 122, 124, or 153.

Automation controllers 122, 124, and 153 may be any device, combination of devices, or network of devices that are implemented in any combination of hardware or software. In one example, the automation controller 122, 124, and 153 is an assembly line controller. In other examples, the automation controller is a controller for a pumping network (e.g., pumps, valves, pipes, sprinklers, and their associated controllers). Other examples of automation controllers and systems that utilize automation controllers are possible.

The automation controllers 122, 124, and 153 communicate to the network 102 via a gateway 151. The gateway 151 provides communication and security functions as is known in the art.

The network 102 also includes a configure module 140, a command module 142, and a monitor module 144 Configuration and re-configuration may include I/O mapping and the definition of attributes and parameters; PLC commands may include executed actions that affect the device such as stopping, starting, clearing, deploying, or re-deploying; and monitoring may include the gathering of data and, in some cases, an action based upon the data such as historian services, remote diagnostics, alarms and notifications.

The configure module 140 includes software and/or hardware that allows control logic to be built, configured, and stored at the communication network 102. A user may manually enter or program the control logic using a GUI. The command module 142 includes software and/or hardware to execute actions based on the control logic 128 to one or both of the automation controllers. The user may select the automation controller using a GUI. The monitor module 144 includes software and/or hardware that allow a user to monitor the operation of one or more automation controllers. All of these modules are implemented on a graphical user interface and may be stored at the memory 126.

A first graphical user interface (GUI) 150 and a second graphical user interface (GUI) 152 are coupled to communication network 102 and specifically to the processor 104. GUI 150 and GUI 152 provide graphical screens that allow a user to navigate across geographic areas, select one or more automation controllers, deploy, (or re-deploy) control logic, and monitor control logic.

In one example of the operation of the system of FIG. 1, GUI 150 and GUI 152 present interactive maps of geographical areas to users and the interactive maps have one or more selectable and navigable display levels. The control logic 128 is stored exclusively at the communication network 102 and at least some a portion of the control logic 128 is stored in a data storage device 126 at the communication network 102. Various portions of control logic are available to multiple users for the use by these users in other pieces of control logic. After selecting the automation controller 122, 124, or 153 the graphical user interface 150 or 152 is used to select at least one function involving the automation controller 122, 124, or 153. The at least one function or action is one or more of configuring operating characteristics of the automation controller and initially deploying the control logic to the automation controller. In other aspects, the function may include re-deploying updated versions of the control logic to the automation controller or monitoring an operation of the control logic that has been deployed at the automation controller. Other examples of functions are possible.

In still other aspects, building the control logic includes manually creating the control logic at the communication network 102. In yet other examples the control logic is purchased from a third party vendor and stored at the network 102.

In still other aspects, a group of secure users is formed at the network 102. Moreover, all members of the group with appropriate permissions may be notified (e.g., via email or some other appropriate means) when an update to the control logic occurs at one of the controllers 122, 124, or 153. Other types of notifications are possible.

In yet other aspects, a group of users is formed and the GUI 150 or GUI 152 provides a single point of control for interactions with the automation controller 122, 124, and 153 for at least a portion of the users in the group. In still other examples, a group of users is formed and the GUI 150 or 152 allows collaboration between various users of the group. Collaboration may include sharing designs, insights, and data to mention a few examples.

Users can be a member of a group, such as a company map or group. In this way, all solution purchasers for a company can add the solution to the company map, so each member of the group can see what has been purchased and where, rather than exploring multiple user maps. As mentioned, users can also be notified of updates or upgrades when made to a solution on the group map. Each user can be part of multiple groups as well as having their own individual map or dashboard. Users can be auto-assigned to groups based on company information or email information.

The present approaches allow users to have a visual representation of their location or hotspots (e.g., plant). Hotspots provide different layers of maps, such as high-level world-wide views, down to an individual automation plant/system views or devices. By adding solutions to groups, members of the same group (e.g., the same company) can view all the solutions within the group.

By creating an interactive site where users can manage their automation controller's (or site's) life-cycle, they are more likely to repeatedly visit, thereby generating more traffic, and resulting in more or increased purchases. From a customer perspective, there is one place where users can view all of the purchased solutions (e.g., control logic), and manage the life-cycle of all their automation controllers. Individual reports for individual locations are not required since the information can be viewed in one place. With all of the solution information on the communication network, users do not need to be within their network to view and make status changes to their control logic. Additionally, a continuous visual model of a user location is provided and provides complete customized packages to be delivered to their location rather than various components requiring assembly (though the individual components can be ordered if needed).

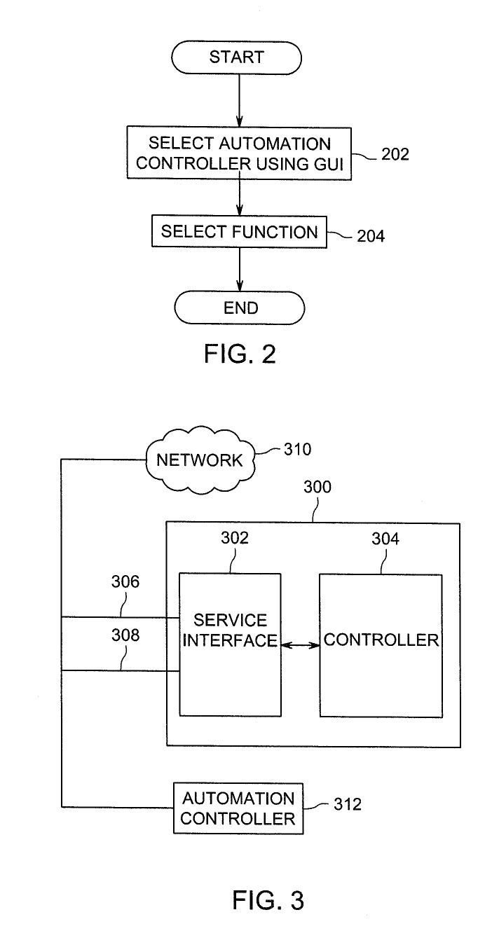

Referring now to FIG. 2, one approach for deploying and monitoring control logic is described. In this example, automation controllers are coupled to a communication network. At step 202, an automation controller is selected using a graphical user interface. The graphical user interface presents an interactive map of a geographical area to a single user and the interactive map has one or more selectable and navigable display levels. Control logic is stored exclusively at the communication network and at least some a portion of the control logic is stored in a data storage device at the communication network. The portion is available to multiple users for their use.

At step 204, after selecting the automation controller, the graphical user interface is used to select at least one function involving the automation controller. The function or action is one or more of configuring operating characteristics of the automation controller and initially deploying the control logic to the automation controller. In other aspects, the function may include re-deploying updated versions of the control logic to the automation controller or monitoring an operation of the control logic that has been deployed at the automation controller. Other functions are possible.

Referring now to FIG. 3, an apparatus 300 for operating automation controllers that are coupled to a communication network 310 includes a service interface 302 and a controller 304. The service interface 302 has an input 306 and an output 308.

The controller 304 is coupled to the interface 302 and is configured to receive a selection of an automation controller 312 from the input 306 of the service interface 302. The controller 312 is also configured to receive a selection of a function to be performed. For instance, a user may begin with a map of a continent or country, and then navigate down to the level of an individual automation controller at a specific or narrow geographic location (e.g., a plant) and select the automation controller. Then, an action may be selected via the output 308. The function or action may, for example, be configuring operating characteristics of the automation controller and/or initially deploying control logic to the automation controller 312. Other functions or actions are possible.

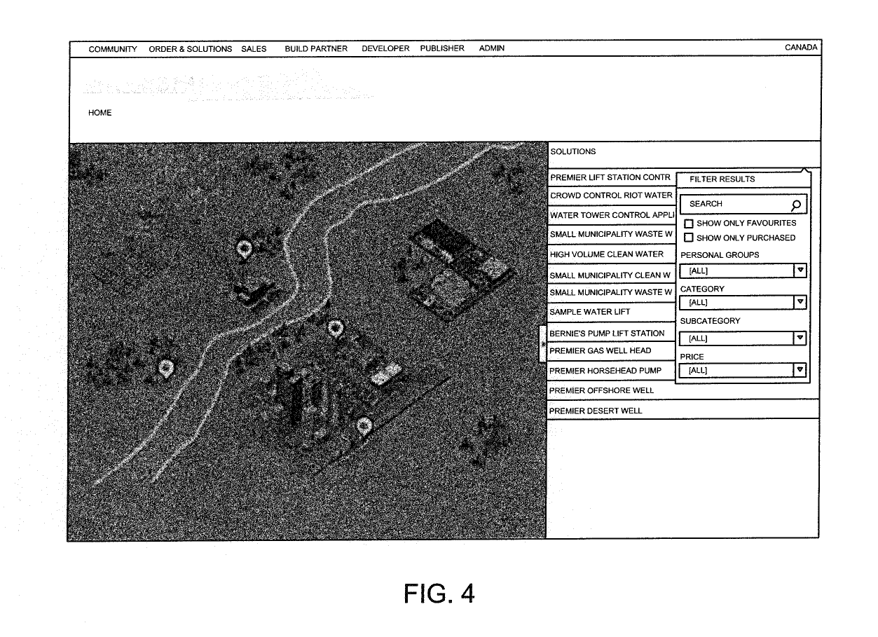

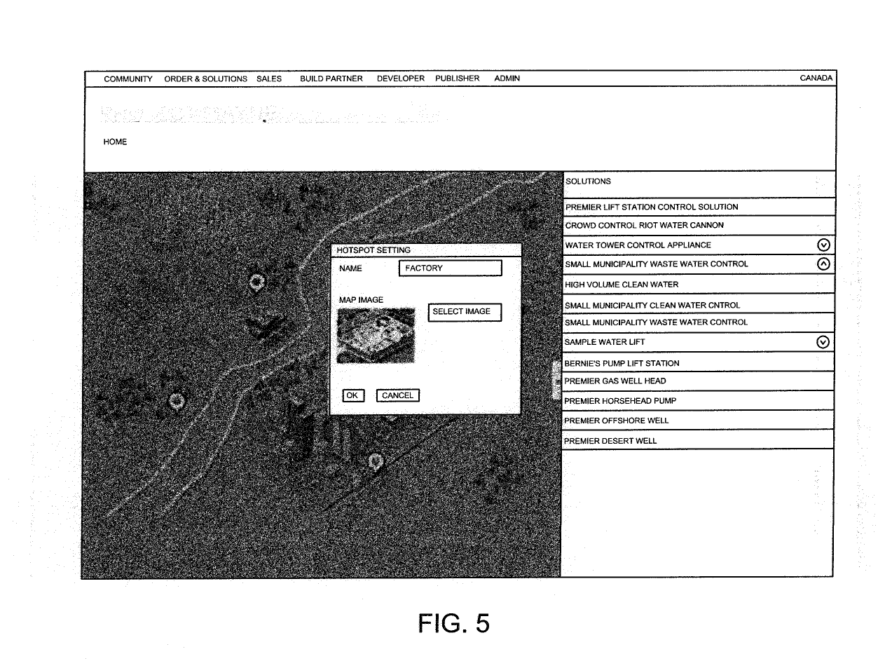

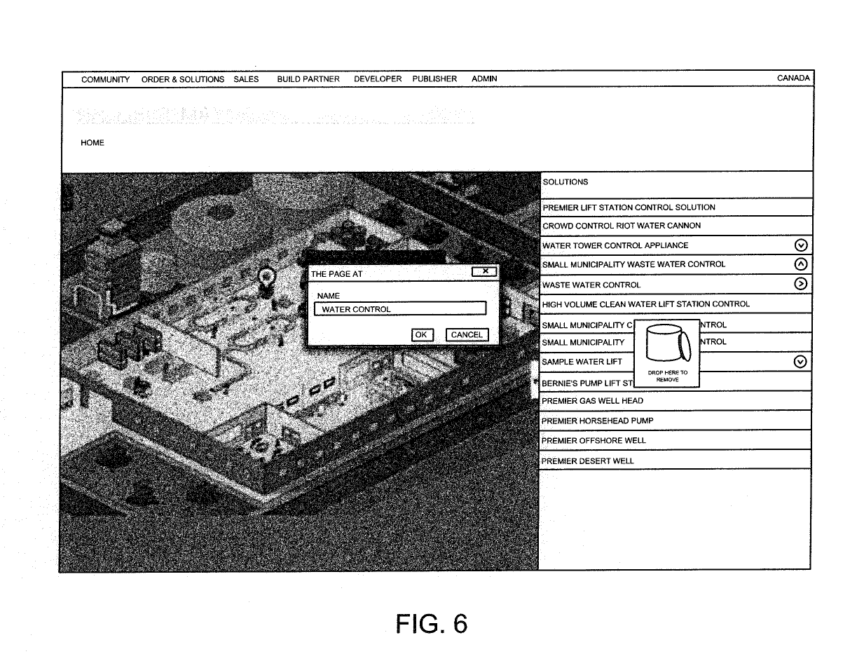

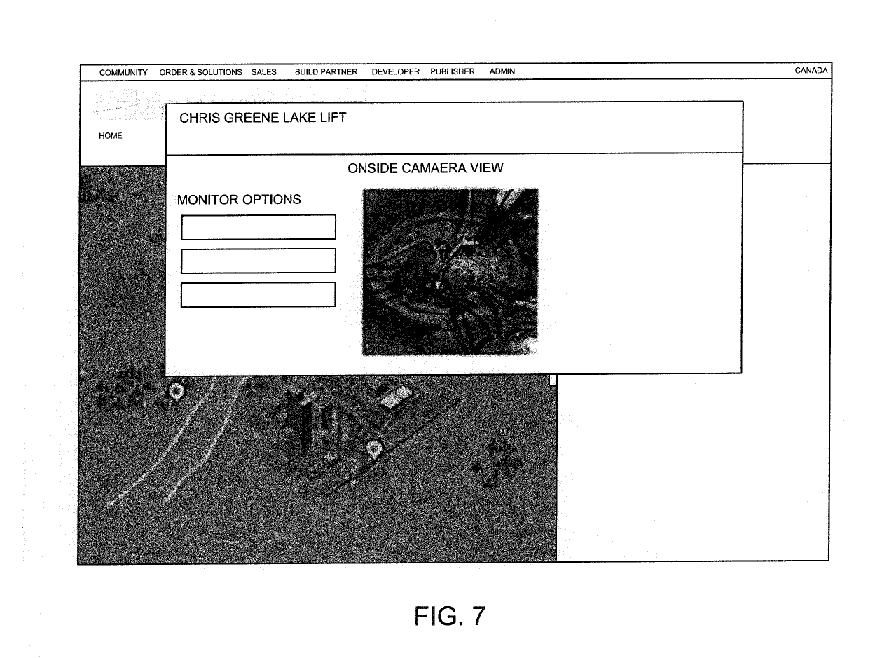

Referring now to FIGS. 4-7, examples of screenshots of a GUI used in deployment and monitoring of control logic are described. FIG. 4 shows an example of a screen showing the general location of a plurality of automation controllers (e.g., at a factory). Subsystems are shown on the right side of the screen. The user may use conventional navigation tools (e.g., a computer mouse) to navigate to more detailed and closer levels of the factory. The results of this action are shown in FIGS. 5 and 6 as successively narrower geographic views are presented. At FIG. 7, a particular automation controller has been chosen and the camera view of that automation controller is displayed. In all of these screens, various parameters of automation controllers can be monitored. In the present example, if the automation controller relates to a pump, the temperature, pressure, and speed of the pump may be monitored. And, as shown, a live camera view of the automation controller may also be available for display to a user.

The screens shown in FIGS. 4-7 show the versatility and flexibility of the present approaches in deploying and monitoring control logic. For instance, users are able to integrate with a web-based geo-physical mapping tool or upload images of their location (e.g., a plant, see FIG. 4). Users then can add control logic (see FIG. 5) and hotspots (see FIG. 6) to create an interactive map of their environment (e.g., physical location and deployed control logic). Instead of merely uploading an image, users can also build a model of their location (e.g., plant) using various pre-defined components (e.g., assembly lines, water tanks, and so forth). The user can drag and drop these components to create a 3D isometric layout. Layered maps can be created by placing hotspots on the original map. Using a hotspot tool, a user can select the location and size of the hotspot on the map and choose a new photo and title to represent the layer (see FIG. 5).

A “breadcrumb” trail showing how deep a user is in the various layers will also allow for navigation back to previously displayed map layers. Automation controllers can be added to the map by selecting a solution from the menu and dragging and dropping to the desired location (see FIG. 6). In one example, automation controllers are represented by pins on the screenshots. An indicator on the pin represents various stages of the solution's order process and “run state” (e.g., not ordered, requires configuration, complete, running, or error state). Users can click on each pin to modify the requirements and/or purchase control logic. Users can also monitor and diagnose the control logic remotely through this same menu (see FIG. 7). The solution menu can be filtered by default categories, by libraries they follow, or searched (see FIG. 4). Individual artifacts or libraries of control logic can also be ordered. That is, a user can order the logic, or hardware, or HMI, and so forth, as they require, rather than being forced to order an entire piece of control logic.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A method of operating automation controllers that are coupled to a communication network, the method comprising:
selecting an automation controller using a graphical user interface, the graphical user interface presenting an interactive map of a geographical area to a single user, the interactive map having one or more selectable and navigable display levels;
storing control logic exclusively at the communication network, at least some portion of the control logic being stored in a data storage device at the communication network, the portion being available to a plurality of users; and
after selecting the automation controller, using the graphical user interface to select at least one function involving the automation controller, the at least one function or action selected from the group consisting of: configuring operating characteristics of the automation controller; and initially deploying the control logic to the automation controller.

2. The method of claim 1, wherein the at least one function further comprises: re-deploying updated versions of the control logic to the automation controller; and monitoring an operation of the control logic that has been deployed at the automation controller.

3. The method of claim 1, wherein building the control logic comprises manually creating the control logic at the communication network.

4. The method of claim 1, further comprising purchasing the control logic from a third party vendor.

5. The method of claim 1, further comprising forming a secure group of users that collaborate.

6. The method of claim 5, further comprising notifying all members of the group when an update to the control logic occurs.

7. The method of claim 1, further comprising forming a group of users, wherein the graphical user interface provides a single point of control for interactions with the automation controller for at least a portion of the group.

8. The method of claim 1, further comprising forming a group of users and wherein the graphical user interface allows collaboration between at least a portion of the users of the group.

9. An apparatus for operating automation controllers that are coupled to a communication network, the apparatus comprising:
a service user interface having an input and an output; and
a controller coupled to the interface, the controller configured to receive a selection of an automation controller from the input of the user interface, the controller configured to after receiving the selection of the automation controller, receive at the input a selection of at least one function involving the automation controller, the at least one function or action selected from the group consisting of: configuring operating characteristics of the automation controller; and initially deploying control logic to the automation controller.

10. The apparatus of claim 9, wherein the at least one function further comprises: re-deploying updated versions of the control logic to the automation controller; and monitoring an operation of the control logic that has been deployed at the automation controller.

11. The apparatus of claim 9, wherein the control logic is manually created at the communication network.

12. The apparatus of claim 9, wherein the control logic is purchased from a third party vendor.

13. The apparatus of claim 9, wherein the controller is configured to form a group of users.

14. The apparatus of claim 13, wherein the controller is configured to notify all members of the group when an update to the control logic occurs.

15. The apparatus of claim 9, wherein the controller is configured to form a group of users, and wherein a graphical user interface coupled to the interface provides a single point of control for interactions with the automation controller for at least a portion of the group.

16. The apparatus of claim 9, wherein the controller is configured to form a group of users and wherein a graphical user interface coupled to the interface allows collaboration between at least a portion of the users of the group.
